(19) United States
(12) Patent Application Publication
(10) Pub. No.: US 2005/0272847 A1
(43) Pub. Date: Dec. 8, 2005

(54) Method of forming nanocomposite materials

(76) Inventors: Chyi-Shan Wang, Beavercreek, OH (US); Max D. Alexander JR., Centerville, OH (US); Chenggang Chen, Beavercreek, OH (US)

Correspondence Address: DINSMORE & SHOHL LLP;One Dayton Centre, Suite 500, One South Main Street, Dayton, OH, 45402-2023, US

(21) Appl. No.: 11/134,937

(22) Filed: May 23, 2005

Related U.S. Application Data
(63) Continuation-in-part of application No. 10/789,295, filed on Feb. 27, 2004.
Application No. 10/789,295 is a continuation-in-part of application No. 10/698,218, filed on Oct. 31, 2003.
Application No. 10/698,218 is a division of application No. 09/932,169, filed on Aug. 17, 2001, now Pat. No. 6,680,016.

(51) Int. Cl. C08K 3/34

(52) U.S. Cl. 524/442; 524/492

(57) ABSTRACT

A method of making a polymeric nanocomposite material. The method includes combining nanosize materials, such as layered silicates, or nanosize sphered silica, with a polymer and a solvent to form a substantially homogeneous mixture, followed by removal of the solvent. The method forms a layered-silicate nanocomposite with an intercalated nanostructure with very large interplanar spacing or a combination of intercalated and exfoliated nanostructure.

### CROSS REFERENCE TO RELATED APPLICATIONS

This application is a continuation-in-part of U.S. patent application Ser. No. 10/789,295 filed Feb. 27, 2004, which is a continuation-in-part of U.S. patent application Ser. No. 10/698,218 filed Oct. 31, 2003, which is a division of U.S. patent application Ser. No. 09/932,169 filed Aug. 17, 2001, now U.S. Pat. No. 6,680,016.

### BACKGROUND OF THE INVENTION

The present invention is directed to a nanocomposite material incorporating uniformly dispersed nanosize materials, and to a method of forming such a nanocomposite material.

It is known that nanosize materials may be used to enhance the mechanical, electronic and thermal transport properties of polymers and other high-performance plastics for use in a variety of applications. For example, vapor-grown carbon nanofibers have been dispersed in polymer matrices by a polymer melt blending method in which the dispersants in the polymer matrix are mechanically sheared apart. See, for example, U.S. Pat. No. 5,643,502. As nanosize materials tend to clump together, this reduces the benefit of their properties when they are incorporated into the polymer matrix. And, as most polymers are incompatible with nanosize materials, it is difficult to achieve uniform dispersion of the materials in the polymer matrix. In addition, the use of high shear mechanical blending can result in the breakage of the nanosize material.

Accordingly, there is still a need in the art for an improved method of reinforcing a polymeric material with nanosize materials which provides a uniform dispersion of the nanosize materials in the polymer matrix and which produces a nanocomposite material having improvement in various mechanical, electrical, and thermal properties.

### SUMMARY OF THE INVENTION

The present invention meets that need by providing a method for uniformly dispersing nanosize materials such as layered silicates into polymer matrices. The uniform dispersion of such nanosize materials in a polymer matrix is achieved by dissolving the polymer in a solvent with the nanosize material to achieve a substantially homogeneous solution, followed by evaporation or coagulation of the solvent. As is well understood, by polymers, we mean that they also include monomers and other polymer precursors which will form polymers later.

According to one aspect of the present invention, a method of forming a polymeric nanocomposite material is provided comprising providing a nanosize layered silicate, providing a polymer comprising a thermoplastic or thermosetting resin, combining the nanosize layered silicate and polymer with a solvent to form a substantially homogeneous mixture, and removing the solvent from the mixture.

### BRIEF DESCRIPTION OF THE DRAWINGS

FIG. 1 are transmission electron microscope (TEM) images of a nanocomposite containing 1.5 wt % organoclay (SC18), epoxy resin (Epon 862), and curing agent (curing agent W) made using stir-bar mixing.

FIG. 2 is a graph showing the small-angle x-ray scattering of the nanocomposite of FIG. 1.

FIG. 3 are TEM images of a nanocomposite containing 2.5 wt % organoclay (SC8), epoxy resin (Epon 862), and curing agent (curing agent W) made using stir-bar mixing.

FIG. 4 is a graph showing the small-angle x-ray scattering of the nanocomposite of FIG. 3.

FIG. 5 are TEM images of a nanocomposite containing 5 wt % organoclay (SC18), epoxy resin (Epon 828), and curing agent (curing agent W) made using high-shear mixing.

FIG. 6 is a graph showing the small-angle x-ray scattering of the nanocomposite of FIG. 5.

FIG. 7 is a TEM image of a nanocomposite containing 2.5 wt % organoclay I.30E), epoxy resin (Epon 862), and curing agent (curing agent W) made using high-shear mixing.

FIG. 8 is a graph showing the small-angle x-ray scattering of the nanocomposite of FIG. 7.

FIG. 9 are TEM images of a nanocomposite containing 2.5 wt % organoclay (SC18), epoxy resin (Epon 828), and curing agent (Jeffamine D230) made using high-shear mixing.

FIG. 10 are TEM images of a nanocomposite containing 2.3 wt % organoclay (SC18), epoxy resin (Epon 828), and curing agent (Jeffamine D400) made using high-shear mixing.

FIG. 11 is a TEM image of a hybrid nanocomposite containing 1 wt % silica, 2 wt % organoclay (SC12), epoxy resin (Epon 862), and curing agent (curing agent W) made using high-shear mixing.

### DETAILED DESCRIPTION OF THE PREFERRED EMBODIMENTS

We have found that the method of the present invention is more effective in uniformly dispersing nanosize materials into polymer matrices than prior art methods such as melt blending. By “uniformly dispersed,” it is meant that the nanosize materials are uniformly dispersed throughout the polymer matrix with minimal degradation of their large aspect ratio. The method of the present invention achieves uniform dispersion of nanosize materials in polymer matrices by dissolving the polymer in a solvent with the nanosize materials. While the nanosize materials of the present invention alone do not disperse well in polymer, we have found that they disperse very well in the presence of a organic solvents. Accordingly, the nanosize materials are combined with the polymer and solvent to form a substantially homogeneous mixture, followed by evaporation or coagulation of the solvent to form the polymeric nanocomposite material. By “substantially homogeneous mixture”, it is meant that the nanosize materials are uniformly dispersed in the solution mixture.

After the solvent is removed, the resulting polymer nanocomposite material can be further processed into various shapes and forms by conventional polymer extrusion and molding techniques.

The method of the present invention provides an advantage over prior melt-blending processes in that it utilizes a low-temperature solution process, (i.e., no heat is required to melt the polymer) to disperse the nanosize materials. The method does not require high shear mixing of the polymer melt at elevated temperatures. However, it should be appreciated that while the use of high shear mixing is not required in the method of the present invention, it may be desirable to use high shear when mixing nanosize materials such as layered silicates to accelerate the mixing of the components to achieve a homogeneous mixture.

The use of nanosize materials comprising layered silicates results in polymeric nanocomposite materials having one or more improved properties. It should be understood that there need not be improvement in all properties for a useful composite. The electrical properties of the nanocomposite, including dielectric constant and dielectric nanocapacitance, are unique and can be tailored to specific applications. The nanocomposites have increased mechanical properties, improved durability, increased dimensional stability, and improved abrasion resistance. They also have a reduced coefficient of thermal expansion, increased thermal capabilities, and improved fire retardancy. The nanocomposites have reduced microcracking and outgassing, reduced permeability, and increased damping capabilities. They also mitigate material property dissimilarities across joints. In addition, they have increased property retention in extreme environments such as atomic oxygen in low earth orbital in outer space, and oxygen plasma. Thus, the nanocomposites of the present invention are multifunctional.

Suitable polymers for use in the present invention include various thermoplastic and thermosetting polymers; however, it should be appreciated that any polymer may be used in the present invention as long as it is soluble in a solvent. Suitable polymers include, but are not limited to, polymers include polyurethanes, polyolefins, polyamides, polyimides, epoxy resins, silicone resins, polycarbonate resins, acrylic resins, and aromatic-heterocyclic rigid-rod and ladder polymers such as poly(benzimidazobenzophenanthroline) (BBL). The polymer is preferably present in a concentration of at least about 80 wt %, preferably higher than about 90%; however, it should be appreciated that the concentration of the polymer may vary depending on the desired properties and applications, such as coatings, of the resulting composite material.

In embodiments where the nanosize material comprises layered silicates, the polymer preferably comprises a thermoplastic or thermosetting resin such as an epoxy resin or silicone resin, a polyolefin, or polycarbonate or acrylic resins. Preferred epoxy resins for use in the present invention include Epon 862 or Epon 828, commercially available from Shell Chemical Co. Preferred silicone resins include Dow Corning Silastic GP30 or Q2901.

Suitable layered silicates for use in the present invention are commercially available from Southern Clay Products, and Nanocore, or can be synthesized through well-established ion-exchange chemistry. Suitable spherical silica is available from Aldrich. The layered silicates and spherical silica can be present in an amount up to about 20 wt % or more in the final product, typically about 1 to about 10 wt %. A concentrate containing a higher weight percentage of layered silicate or spherical silica could be prepared, and the concentrate could be diluted with polymer to form the final desired product.

In embodiments where the polymer comprises a thermosetting resin, a curing agent is preferably added after removing the solvent from the mixture to cure the resin. Suitable curing agents for use in the present invention include amines, anhydrides, and optionally accelerators. Preferred amines include multi-functional amines. Suitable curing agents include, but are not limited to, diethyltoluenediamine available from Shell; Jeffamine® curing agents (such as D230, D400, D2000, and T403) available from Huntsman Chemical; diethyltriamine; triethylene tetramine; 4,4′-diaminodiphenylmethane; polyaminoamide; and nadic methyl anhydride. The accelerators can be weak bases such as tertiary amines (benzyldimethylamine), and imidazole derivatives An optional coupling agent may also be added; suitable coupling agents include, but are not limited to, 3-glycidoxypropyltrimethoxy silane or 3-aminopropyltrimethoxy silane.

Suitable solvents for use in the present invention include, but are not limited to, acetone, methylethyl ketone, tetrahydrofuran, methylene dichloride, chloroform, toluene, xylene, 1-methyl pyrrolidinone, N,N-dimethyl acetamide, N,N-dimethyl foramide, dimethyl sulfoxide, polyphosphoric acid, butyl acetate, water, and mixtures thereof.

The method of the present invention is preferably carried out by mixing the nanosize material and the desired polymer in a solvent, preferably in a closed container. This can be accomplished in a number of ways, with or without high shear mixing. The nanosize material may be dispersed in the solvent, the polymer mixed with solvent, and the two mixtures mixed together. Alternatively, the nanosize material can be dispersed in the solvent, and the polymer (without solvent) added; the nanosize material, polymer and solvent may be combined at the same time; or the nanosize material can be mixed with the polymer and the solvent then added. The preferred method of combining the components will vary depending on the solubility of the polymer being used.

In the method of preparing the nanocomposite, it may be desirable to include a dispersing agent when mixing the nanosize material with the polymer and solvent to ensure a uniform dispersion of the materials. Suitable dispersing agents for use in the present invention include oils, plasticizers, and various surfactants. Suitable oils include vegetable and mineral oils including, but not limited to, castor oils, modified castor oils, soybean oils, modified soy bean oils, rape seed and canola oils, mineral oils, petroleum greases and lubricants. Suitable plasticizers include adipates, esters, oleates, phthalates, epoxides, and polymeric and monomeric plasticizers commonly used in industrial and specialty applications.

The resulting nanocomposite material may be further processed according to the desired application. For example, the nanocomposite material may be formed into a thin film which is cast from the solution mixture by evaporating the solvent at a temperature which is at or below the boiling point of the solvent. Alternatively, the solvent may be removed by coagulation in which the solution mixture is formed into a film or fiber and then immersed in a nonsolvent, such as water, to coagulate the film. The solution mixture may also be formed into thin films by spin coating and dip coating methods. The solution mixture may also be formed into large components such as thick sheets or panels by spraying or deposition, or by extruding or molding the dried composite material.

The nanocomposite material may be formed into structural adhesives, coatings, inks, films, extruded shapes, thick sheets, molded parts, and large structural components.

In order that the invention may be more readily understood, reference is made to the following examples which are intended to illustrate the invention, but not limit the scope thereof.

### EXAMPLE 1

Samples of spherical silica epoxy nanocomposites and layered silicate epoxy nanocomposites were formed using the method of the present invention in which sphered silica nanoparticles or nanosheets of layered silicate were combined with acetone followed by the addition of an epoxy resin (Epon 862 or Epon 828 from Shell), a curing agent (Jeffamine® from Huntsman Chemical) with or without a coupling agent (3-glycidoxypropyltrimethoxy silane or 3-aminopropyltrimethoxy silane).

The introduction of nanosize spherical silica into the epoxy resin resulted in good dispersion without significant precipitation.

The dispersion of the nanosheets in the epoxy resin matrix was relatively good. Despite these initial conclusions, additional testing has shown that the spherical silica particles were aggregated, and the silicate nanosheets were stacked together. The layered silicates are intercalated nanocomposites or a mixture of intercalated and partially exfoliated nanocomposites, as discussed below.

A series of experiments were run to compare the effect of the method of mixing of the present invention with the stir-bar method for layered silicates. In the stir-bar mixing method, an epoxy resin and the organoclay were mixed using a stirring bar at elevated temperature (about 60° C.) for about 2 to 4 hours. The mixture was degassed and the stoichiometric amount of curing agent was added. The mixture was degassed and cured in the mold.

### EXAMPLE 2

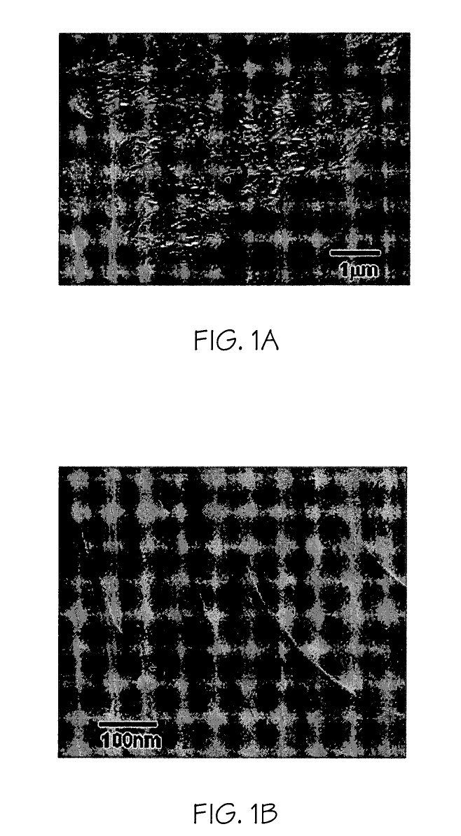

A nanocomposite was made with 1.5% organoclay (SC18), epoxy resin (Epon 862), and a curing agent (curing agent W (diethyltoluenediamine)) using the stir-bar method. The x-ray diffraction of the cured nanocomposite shows that the interplanar spacing is more than 100 Å. Although an exfoliated nanostructure is often assumed in most literature when x-ray diffraction cannot detect the (001) peak of the epoxy nanocomposite (mostly beyond about 80 Å), we have found that they are not strictly exfoliated at all. The TEM image of FIG. 1 shows that the silicate nanosheets are stacked together. The size for the aggregation is from 1 to teen μm. The interplanar spacing is from about 100 to about 200 Å.

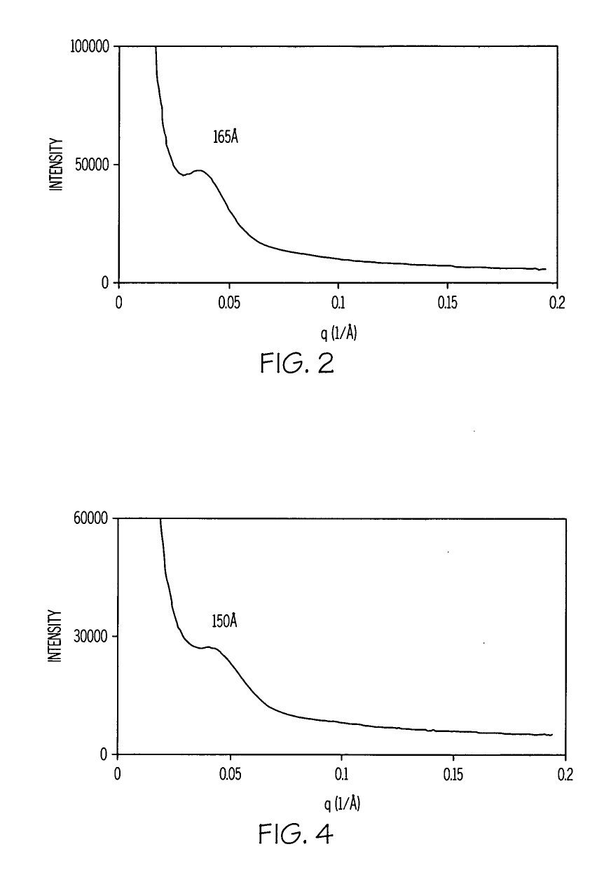

The small-angle x-ray scattering was used to characterize the morphologies of the nanocomposites further. The small-angle x-ray scattering (SAXS) of this nanocomposite is shown in FIG. 2. SAXS data indicated that the interplanar spacing is about 165 Å in the ordered structure of the nanocomposite. Compared with the original interplanar spacing of 18.0 Å of organoclay SC18, the gallery of the organoclay was greatly expanded. The expansion of the gallery is due to the penetration of the large amount of epoxy resin inside the gallery. The expansion is so large that the dispersion of the layered silicate in the polymer matrix is good. However, it is an intercalated nanocomposite with very large interplanar spacing (165 Å).

### EXAMPLE 3

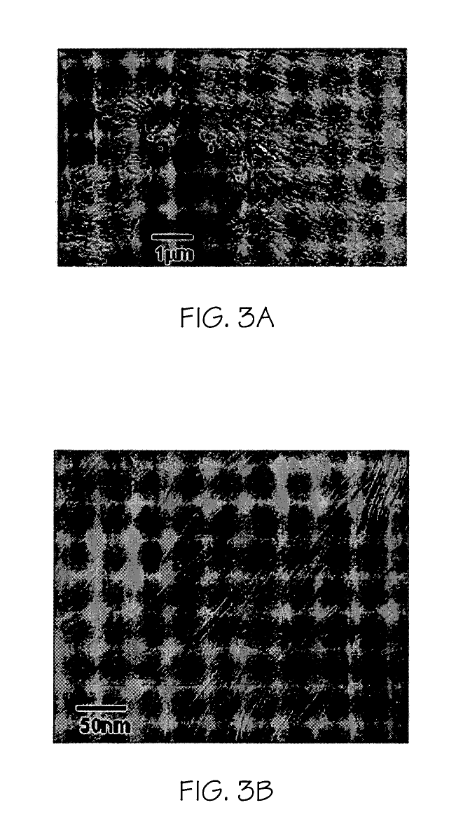

A nanocomposite was made with 2.5% organoclay (SC8), epoxy resin (Epon 862), and a curing agent (curing agent W). The TEM image is shown in FIG. 3. The particle size is very large. Some particles can be as large as teen μm. The TEM image at high magnification shows that the interplanar spacings in the gallery of the clay nanosheets is typically from 15 to 20 nm. The small-angle x-ray scattering of this nanocomposite is shown in FIG. 4. SAXS data indicated that the interplanar spacing of this nanocomposite is about 150 Å. The gallery of the organoclay was expanded significantly as compared to the original interplanar spacing of 13.4 Å of organoclay SC8. It is an intercalated nanocomposite with very large interplanar spacing (150 Å).

The high-shear mixing method of the present invention was also evaluated. In this method, the organoclay was dispersed in a solvent (acetone) using a high-shear mixer in a sonication bath for about 3 to 6 hours. The epoxy resin and acetone mixture was then added to the suspension and mixed by high-shear mixing in the sonication bath. After the high-shear mixing, the solvent was evaporated. The curing agent was added to the mixture, which was degassed, and cured.

### EXAMPLE 4

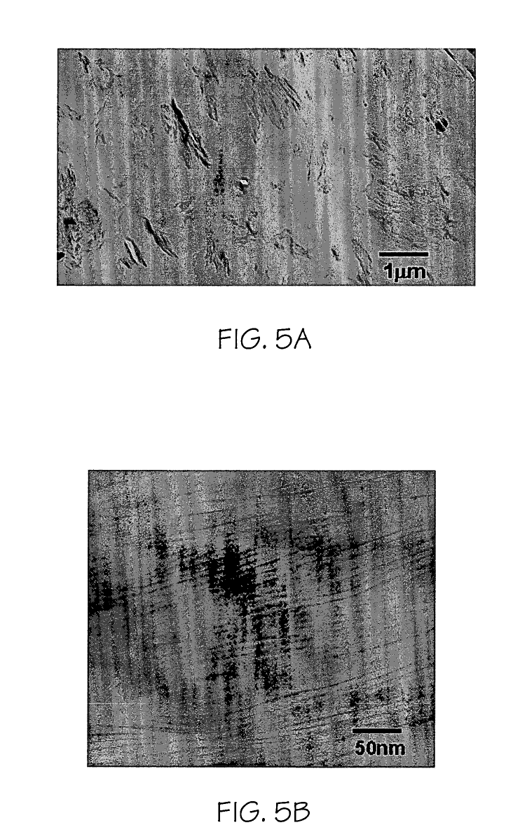

A nanocomposite was made with 5% organoclay (SC18), epoxy resin (Epon 828), and a curing agent (curing agent W). The TEM images are shown in FIG. 5. The images show that the organoclays are broken into smaller particles, but that the size is from 0.1 to 2 μm, and the individual clay nanosheets are stacked together. The particle containing the stacking clay nanosheets is much smaller than the particle using the stir-bar mixing method. The particle size is also determined by the shearing tool, which is generally for the micron-sized particle separation, not for the nanometer-sized particle separation. The interplanar spacing between the nanolayers is about 150 Å, which is consistent with the SAXS data, discussed below. In addition, the TEM image clearly showed that the organoclay was relatively well dispersed in the whole polymer matrix compared with stir-bar mixing.

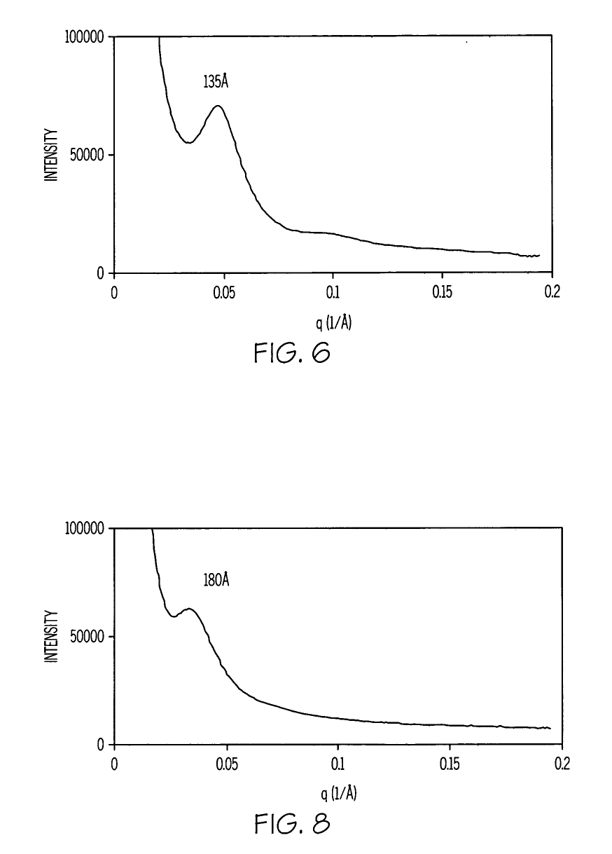

The small-angle x-ray scattering of this nanocomposite is shown in FIG. 6. SAXS data indicated that the interplanar spacing is about 135 Å in the ordered structure of the nanocomposite. Compared to the original interplanar spacing of 18.0 Å of organoclay SC18, the gallery was greatly expanded. However, each particle contains stacking of the individual nanosheets. The morphology of this nanocomposite using the high-shear mixing process is an intercalated nanostructure with a large interplanar spacing (135 Å) and with better dispersion in the polymer matrix than nanocomposites made with stir-bar mixing.

### EXAMPLE 5

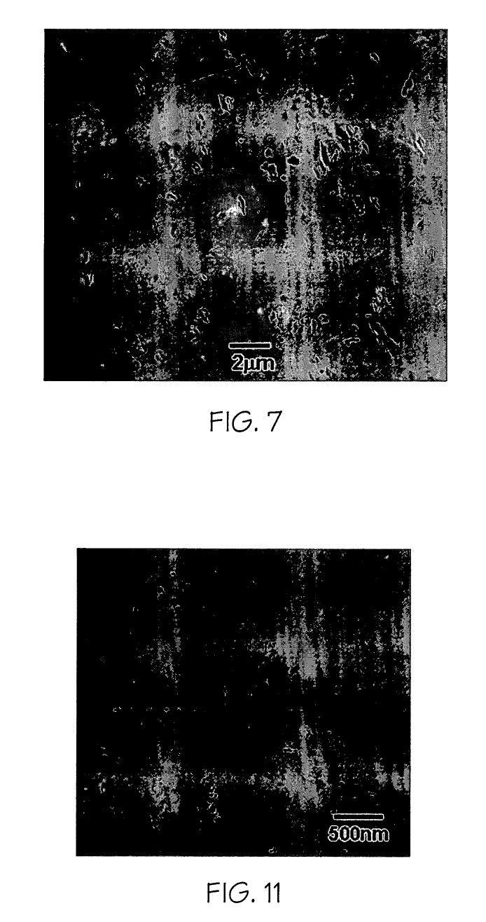

A nanocomposite was made with 2.5% organoclay I.30E from Nanocor), epoxy resin (Epon 862) and a curing agent (curing agent W). The TEM image is shown in FIG. 7. The image is very similar to the TEM images in FIG. 5, indicating relatively good dispersion with particle size from 0.1 to 1-2 μm, which is composed of the stacking of individual clay nanosheets.

The small-angle x-ray scattering of this nanocomposite is shown in FIG. 8. SAXS data indicated that the interplanar spacing is about 180 Å in the ordered structure of the nanocomposite. Compared with the original interplanar spacing of about 22 Å of organoclay I.30E, the gallery of the organoclay was greatly expanded. It is an intercalated nanostructure with very large interplanar spacing (180 Å). The aggregation size of the layered silicate is smaller, and they are better dispersed in the whole polymer matrix than nanocomposites made with stir-bar mixing.

### EXAMPLE 6

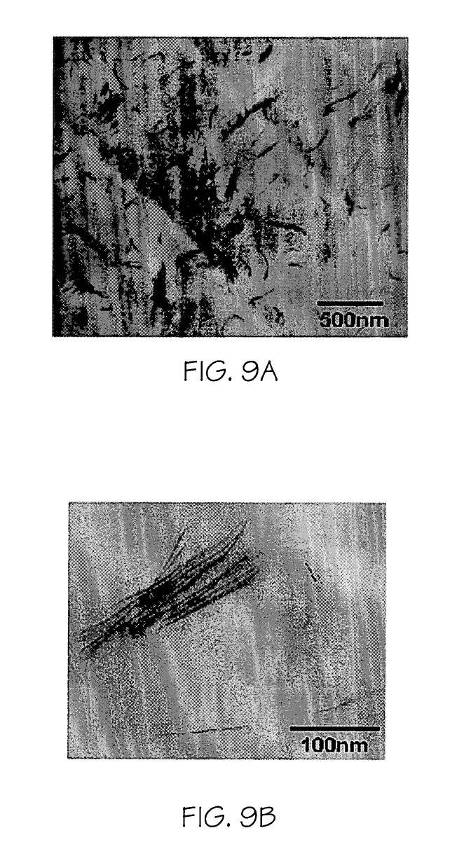

A nanocomposite was made with 2.5% organoclay (SC18), epoxy resin (Epon 828), and a curing agent (Jeffamine D230). The TEM image is shown in FIG. 9. The dispersion of the layered silicate is very good. However, each particle contains one to several individual silicate nanosheets. It has a mixed morphology of a combination of intercalated and partially exfoliated nanostructure.

### EXAMPLE 7

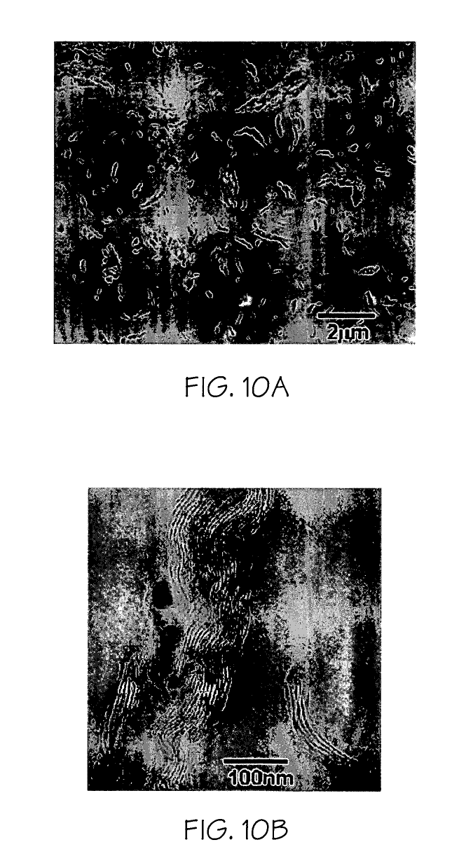

A nanocomposite was made with 2.3% organoclay (SC 18), epoxy resin (Epon 828), and a curing agent (Jeffamine D400). The TEM image is shown in FIG. 10. The dispersion of the layered silicate in the whole matrix is very good. But each particle contains several individual silicate nanosheets. It has the mixed morphology of a combination of intercalated and partially exfoliated nanostructure.

### EXAMPLE 8

A nanocomposite was made with 2% organoclay (SC 12), 1% SiO₂, epoxy resin (Epon 862), and a curing agent (curing agent W). The desired amount of the spherical silica organoclay was mixed with acetone by high shear mixing in the ultrasonication bath for about 2 hours. Then, the desired amount of Epon 862 with acetone was added, and high shear mixing of the resulting mixture in the ultrasonication bath was continued for 6 hours. The solvent was evaporated, and the mixture degassed. Then, the stoichiometric amount of curing agent W was added and mixed by stir bar. The mixture was degassed and cured. The TEM image of this nanocomposite is shown in FIG. 11. The TEM image shows that the spherical silica particles and layered-silicate are dispersed in the epoxy matrix. Although the dispersion is relatively good, both the spherical silica and layered-silica are in the state of small aggregation.

The high-shear mixing of the layered-silicates provides a nanocomposite having a morphology which is either intercalated or a combination of intercalated and partially exfoliated.

It will be obvious to those skilled in the art that various changes may be made without departing from the scope of the invention which is not to be considered limited to what is described in the specification.

1. A method of forming a polymeric nanocomposite material comprising:
providing nanosize material selected from layered silicates and spherical silica;
providing a polymer comprising a thermoplastic or thermosetting resin;
combining the nanosize material and the polymer with a solvent to form a substantially homogeneous mixture; and
removing the solvent from the mixture.

2. The method of claim 1 wherein the thermoplastic or thermosetting resin is selected from epoxies, silicones, polyolefins, polycarbonates, acrylics, or combinations thereof.

3. The method of claim 1 further comprising adding a curing agent after removing the solvent from the mixture.

4. The method of claim 3 wherein the curing agent is selected from amines, anhydrides, or combinations thereof.

5. The method of claim 1 wherein the solvent is removed by evaporation.

6. The method of claim 1 further comprising adding a dispersing agent when combining the nanosize material, polymer, and solvent.

7. The method of claim 6 wherein the dispersing agent is selected from oils, plasticizers, surfactants, or combinations thereof.

8. The method of claim 1 in which the solvent is selected from acetone, methylethyl ketone tetrahydrofuran, methylene dichloride, chloroform, toluene, xylene, 1-methyl pyrrolidinone, N,N-dimethyl acetamide, N,N-dimethyl foramide, dimethyl sulfoxide, polyphosphoric acid, butyl acetate, water, or mixtures thereof.

9. The method of claim 1 further comprising adding a coupling agent.

10. The method of claim 1 wherein combining the nanosize material, polymer, and solvent comprises using high shear mixing.

11. The method of claim 1 wherein the nanosize material is combined with the solvent before the polymer is added.

12. A method of forming a polymeric nanocomposite material comprising:
providing nanosize layered silicate;
providing a polymer comprising a thermoplastic or thermosetting resin;
combining the nanosize layered silicate and the polymer with a solvent using high shear mixing to form a substantially homogeneous mixture; and
removing the solvent from the mixture;
wherein the polymeric nanocomposite material has a morphology selected from intercalated with a very large interplanar spacing or a combination of intercalated and exfoliated.

13. The method of claim 12 wherein the thermoplastic or thermosetting resin is selected from epoxies, silicones, polyolefins, polycarbonates, acrylics, or combinations thereof.

14. The method of claim 12 further comprising adding a curing agent after removing the solvent from the mixture.

15. The method of claim 14 wherein the curing agent is selected from amines, anhydrides, or combinations thereof.

16. The method of claim 12 wherein the solvent is removed by evaporation.

17. The method of claim 12 further comprising adding a dispersing agent when combining the nanosize layered silicates, polymer, and solvent.

18. The method of claim 17 wherein the dispersing agent is selected from selected from oils, plasticizers, surfactants, or combinations thereof.

19. The method of claim 12 in which the solvent is selected from acetone, methylethyl ketone, tetrahydrofuran, methylene dichloride, chloroform, toluene, xylene, 1-methyl pyrrolidinone, N,N-dimethyl acetamide, N,N-dimethyl foramide, dimethyl sulfoxide, polyphosphoric acid, butyl acetate, water, or mixtures thereof.

20. The method of claim 12 further comprising adding a coupling agent.

21. The method of claim 12 wherein the nanosize layered silicate is combined with the solvent before the polymer is added.

22. The polymeric nanocomposite material made by the method of claim 1.

23. The polymeric nanocomposite material made by the method of claim 12.
